(19) United States
(12) Patent Application Publication
(10) Pub. No.: US 2003/0182840 A1
(43) Pub. Date: Oct. 2, 2003

(54) Simulated-motion decoy

(76) Inventor: David E. Colley, Loganville, GA (US)

Correspondence Address: SHOEMAKER AND MATTARE, Suite 1203, 2001 Jefferson Davis Highway, Arlington, VA, 22202-0286, US

(21) Appl. No.: 10/108,506

(22) Filed: Mar. 29, 2002

(51) Int. Cl. A01M 31/06

(52) U.S. Cl. 43/3

(57) ABSTRACT

A simulated-motion decoy has a lenticular device on at least part of its body, disposed so as to be visible to a passing bird or game animal and thus providing a changing image as the bird or game animal's viewing angle changes.

### BACKGROUND OF THE INVENTION

This invention relates to hunting game decoys.

Decoys have been used in the sport of hunting for ages to attract game animals and birds. Many types of decoys and methods of their use are commonly known.

To perform its function, a decoy should be as realistic as possible. In the case of duck decoys, for instance, an accurate depiction of the color and texture of the feathers along with other features such as unique markings, the shape of the head and body, and so forth, contribute to the ability of the decoy to lure live ducks to the hunter's duck blind. The more accurately the decoy or set of decoys create the illusion of live ducks in the area, the more successful the hunter will be in attracting them into range. Therefore, the art of creating decoys has focused largely on the accuracy of representation of the features of birds or other animals.

Duck decoy makers have gone so far as to construct decoys having battery powered, rotating wings that are a light color on one side and a dark color on the opposite side, to simulate the flapping of wings like a duck landing on the water. This simulation of motion produces an added dimension of realism to the decoy, and has proven to be highly successful in attracting ducks. The makers of other types of decoys, such as goose decoys, wild turkey decoys, deer decoys and the like have also incorporated motorized or other mechanical components into a decoy to simulate live motion, thus enhancing the decoy's effectiveness.

There are a number of distinct disadvantages to decoys having moving components, whether driven by motors or other mechanical means. One disadvantage is that any moving part is subject to failure. Another disadvantage is that motorized devices require some power source to operate. In the case of the duck decoy with rotating wings, driven by a battery-powered electric motor, the battery requires either routine recharging or replacement. Also, wire connections are required to connect the power source to the motor, making setting up the decoy for use somewhat labor intensive. Battery-powered devices, while they may be effective, are expensive to purchase, operate and maintain.

Another important factor is compliance with hunting laws and regulations. Today's technology makes it possible to create not only lifelike robotic replicas of animals such as dinosaurs, but also very persuasive bird decoys. Perhaps from a sense of fair play, many states today forbid or are considering banning decoys which utter sounds, or which have mechanical moving parts. Passive devices are still permitted in many places, these being decoys which have parts that move only under the influence of a natural force such as wind: fabric wings which flap in the breeze are one example.

It would be of great benefit to the hunter to have a decoy capable of producing the illusion of the movement of a live animal or bird, such as the flapping of the wings of a duck, but one that did not rely on any mechanical means, motor, power supply or moving parts to create such an illusion.

### SUMMARY OF THE INVENTION

An object of the invention is to provide a hunting game decoy which has no moving parts, motor-driven or otherwise, yet which appears to change or move when viewed by a moving bird or other game.

These and other objects are attained by a simulated-motion decoy as described below.

The present invention produces the realistic illusion of movement in a decoy without necessitating a motor, power source, or any moving parts. This is accomplished by employing optical materials and methods that have been used previously for other purposes.

The optical materials involved combine two or more images into one composite picture, by dividing each image into strips. The strips are then assembled in alternating sequence in a process called interlacing. When viewed alone, an interleaved image may bring to mind a “double-exposure” type photograph. However, when the image is placed behind a specially designed screen made of a clear plastic material, and having grooves or ribs on one surface arranged at a pitch equal to that of the strip, the strips are magnified widthwise, so that the strips of only one image are visible at a time. Now the original images may be seen independently, depending upon the angle of view, and as the angle of view changes, the images are seen alternately. If the images depict different positions of a common theme, the illusion of motion is produced. Alternatively, the images may be contrasting: for example, one image could be entirely white, and one entirely black. In this case, the interleaved image would be an array of alternating black and white stripes, and a moving observer would perceive an image which changed from black to white. Lenticular devices have been used to create novelty items, signage, advertising materials and the like, but not to create realistic illusions in decoys.

The lenticular devices contemplated have an interleaved image placed behind a lined screen. These lines or ribs define parallel lenses called lenticules, as is well known in the display graphic arts. Lenticular film, for example, is an extruded plastic with precisely measured half-cylindrical plastic ridges which serve as the lenses. Lenticular devices produce a variety of effects including flipping, i.e., switching between two or more different images by shifting the viewing position. Motion of the observer creates the impression that the image is either rotating on an axis or moving in one or more directions. Morphing creates the illusion of an image transforming into a totally different one. Zooming, using multiple sizes of the same image, gives the effect of an object becoming larger or smaller. Three-dimensional approaches using layering of multiple graphic elements to produce an illusion of depth in a two-dimensional image is also known. While this is only effective when the viewer is standing still, it is included here for completeness of this process. Graphic-design software can reduce the tedious manual process of interlacing to an exact procedure.

The picture will appear as sliced segments representing a range of viewing angles. The images of the game sought to be attracted, are so arranged that their motion is complementary. This is accomplished by different positions of the game. A bird for example will be seen as flapping its wings and its complementary image shown in the preparation for another wing stroke of the flapping motion. To the game, the decoy creates a sense of motion, not by the decoy moving, but rather by the game animal or fowl, moving past the decoy which appears to move. It is the visual merger of the decoy segments that creates the illusion of continuous motion.

In one example, the device itself is constructed of a sheet of lenticular material, with an image of a game animal or fowl attached to its rear surface. The image is printed and formed in multiple slices whose individual slices present a view or image of the game, each from a slightly different angle.

### BRIEF DESCRIPTION OF THE DRAWINGS

FIGS. 1 and 2 are perspective views of a simulated-motion decoy embodying the invention, and

FIG. 3 is a side elevation of an alternative embodiment of the invention.

### DESCRIPTION OF THE PREFERRED EMBODIMENT

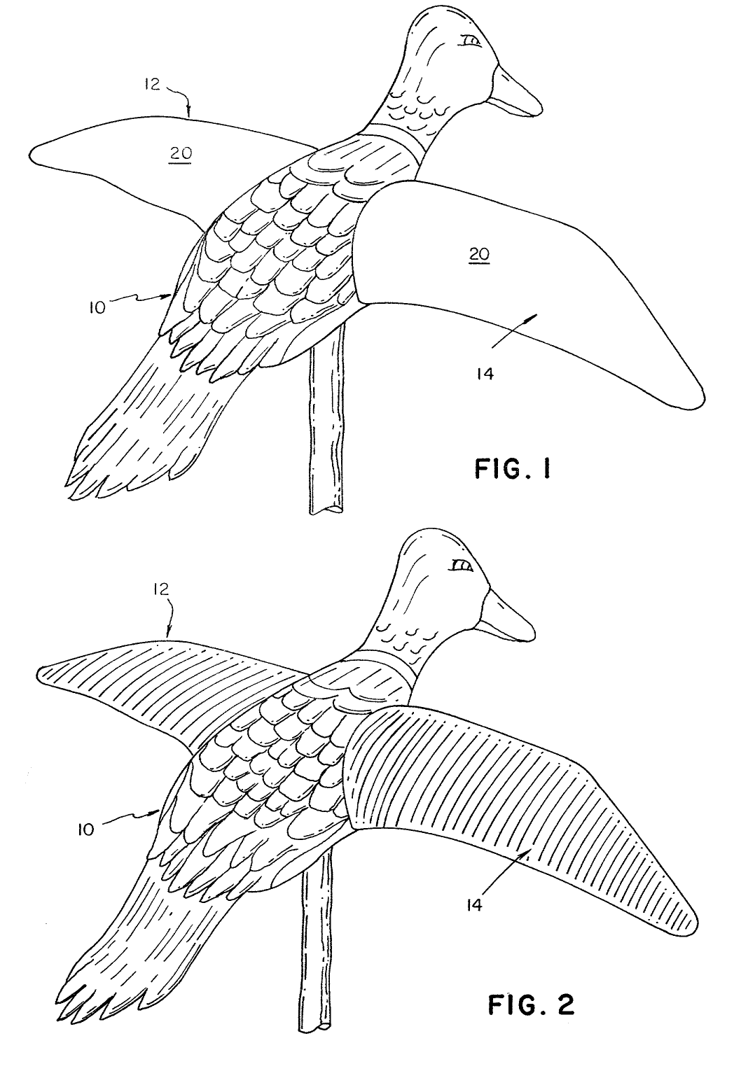

A simulated-motion decoy, as shown in FIG. 1, comprises a simulated animal having a body 10. The removable wings 12, 14 of the decoy each have a lenticular split image screen 20 applied to upper side thereof. The multiple images displayed alternately by the screen may be simply contrasting shades of very dark and very light colors such as black and white. Such shades may be arranged with respect to the alternating lines in the composite such that the alternative views will be of dramatic contrast. At different angles of view, either the light image (FIG. 1) or the dark image (FIG. 2) is observed. The rapid changing of wing colors is perceived, at a distance, as flapping of the wings, although the wings do not move.

As a bird such as a goose or duck flies over the decoy, its angle of view of the decoy continuously changes, and it perceives a moving wing effect. Thus, it is the movement of the bird, not movement of the decoy, that actually creates the illusion of movement of the decoy's wings.

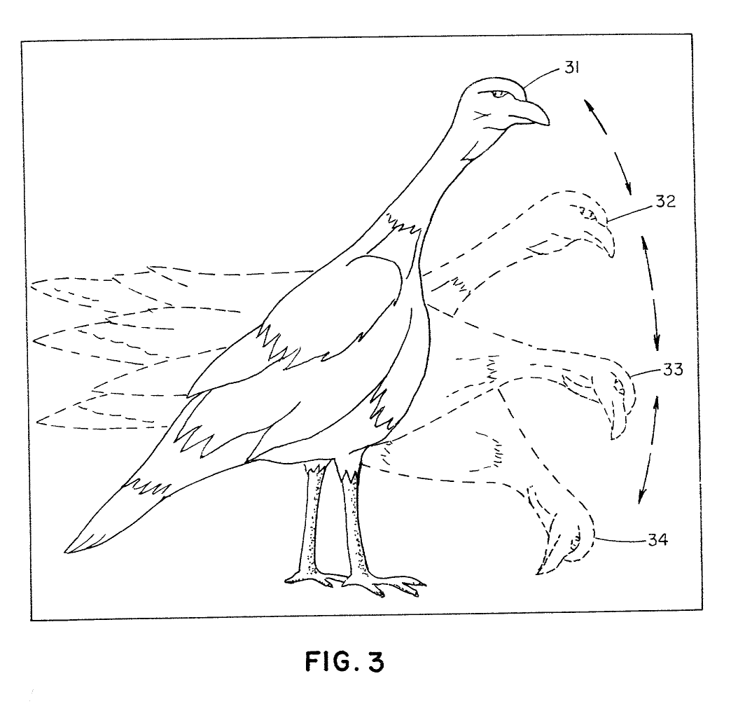

FIG. 3 depicts another form of the invention. Here, a wild turkey is illustrated on a lenticular panel in each of several alternative images; the turkey's head is poised upward in the image 31 presently seen, as represented by solid lines. The broken lines represent three other attitudes 32, 33, 34, in which the head is progressively lowered, and the tail progressively raised. As one's angle of view changes, one sees apparent movement of the head and tail. From a distance, an image of a turkey raising and lowering its head appears, even though the device itself is motionless.

It should be understood that the invention is not limited just to the embodiments described above. It may be used in the same manner to create similar effects and illusions with respect to decoys of other animals such as deer. In the case of a deer decoy, the alternating images might depict the upward and downward movement of the head of the deer as when the deer is feeding, or the common “flicking” motion of the tail. Thus is can be readily recognized that the present invention may have applications with respect to virtually any game animal. The decoys may have alternative modes of use, including luring certain animals into temporary captivity in order to safely relocate them to other areas.

The invention may be practiced with devices other than lenticular devices, such as reflective composites or more advanced devices currently available or to be invented subsequently. In its broadest sense, the invention is considered as including any material or combination of materials capable of creating the illusion of motion by virtue of changing angle of view, without the device itself having to be in motion.

Since the invention is subject to modifications and variations, it is intended that the foregoing description and the accompanying drawings shall be interpreted as only illustrative of the invention defined by the following claims.

I claim:

1. A hunting game decoy having
a body portion, and
a passive device, on at least part of the body portion, for alternately displaying plural images when viewed from different angles, thereby producing an apparent change in appearance to passing game.

2. The game decoy of claim 1, wherein the plural image displaying device is a
a lenticular device on at least part of the body, the lenticular device comprising a plurality of lenticular lenses and an interleaved image viewable through said plurality of lenses, the interleaved image including alternating strips of plural images arranged beneath the lenticular lenses in such a way that alternate images are seen from different viewing angles.

3. The game decoy of claim 1, wherein the game is a water fowl.

4. The game decoy of claim 1, wherein the game is a deer or turkey.

5. A method of attracting game, comprising steps of
providing a game decoy with a passive device for alternately displaying plural images when viewed from different angles, thereby producing an apparent change in appearance to passing game.

6. The method of claim 5, wherein the plural image displaying device is lenticular device on at least part of the decoy, the lenticular device comprising a plurality of lenticular lenses and a composite image viewable through said plurality of lenses, wherein the composite image includes a set of alternating image strips arranged beneath the lenticular lenses in such a way that alternate images are seen from different viewing angles.
